(19) United States
(12) Patent Application Publication
(10) Pub. No.: US 2025/0173397 A1
(43) Pub. Date: May 29, 2025

(54) Computing device having a non-volatile weight memory

(71) Applicant: ANAFLASH INC., Sunnyvale, CA (US)

(72) Inventors: Sihwan Kim, San Francisco, CA (US); Seung-Hwan Song, Palo Alto, CA (US)

(21) Appl. No.: 18/963,381

(22) Filed: Nov. 27, 2024

Related U.S. Application Data
(60) Provisional application No. 63/603,122, filed on Nov. 28, 2023.

(51) Int. Cl. G06F 17/16; G06F 9/30; G06F 13/42

(52) U.S. Cl. CPC G06F 17/16; G06F 9/30043; G06F 13/4234

(57) ABSTRACT

A computing device comprises: a dynamic random access memory (DRAM) storing one or more input matrices, each containing numeric inputs; a non-volatile memory device storing one or more weight matrices; a processor comprising a pair of static random access memories (SRAM), the processor can: load the input matrix from the DRAM into a first SRAM of the pair and the weight matrix from the non-volatile memory device into a second SRAM of the pair, execute matrix operations on the loaded input matrix and the weight matrix; and transfer a corresponding output matrix from the matrix operations to the DRAM, wherein a first SRAM is connected to the DRAM via a data bus and a second SRAM is connected to the non-volatile memory device via one or more direct channels independent from the data bus, allowing a direct transfer of the weight parameters from the non-volatile memory to the first SRAM.

### CROSS-REFERENCE TO RELATED APPLICATIONS

This application claims priority to and the benefit of Provisional U.S. Patent Application No. 63/603,122, filed on Nov. 28, 2023.

### TECHNICAL FIELD OF THE INVENTION

This disclosure relates, in general, to the field of computing systems and, more particularly, to a processor for the computation of neural networks with non-volatile memory (NVM).

### BACKGROUND OF THE INVENTION

Artificial neural networks are increasingly used in artificial intelligence and machine learning applications. Large Language Models (LLMs) such as ChatGPT are among the most powerful and widely used tools in this field. Transformer-based LLMs require large-capacity memory to store pre-trained weight parameters and a large number of matrix multiplication operations. Generally, non-volatile memory (NVM) is used to store large volumes of data, whereas dynamic data is stored in DRAM during processing or computation. A small portion of the data needed for the current computation is transferred from DRAM to the processor's internal SRAM. Based on this data in SRAM, the processor's ALU performs computations, and the results are then stored back in DRAM.

Each storage type, SRAM, DRAM, and NVM, has different typical capacities and read speeds. SRAM has a capacity in the tens of megabytes (MB) range, with a typical read speed within a processor clock cycle, usually under one nanosecond. DRAM has a capacity of several gigabytes (GB) and a read speed in the tens of nanoseconds.

NVM, on the other hand, can store a few terabytes (TB) but has a much slower read speed, around tens of microseconds. The processor, DRAM, and NVM share a data bus in conventional computing devices. As a result, when transferring the vast amount of pre-trained weight parameters stored in NVM for LLM calculations, the slow read speed of NVM creates a bottleneck on the data bus. This can lead to significant performance degradation in the computing device. The present invention describes a computing device with a tiered memory architecture that includes DRAM for dynamic data and NVM for static data, such as pre-trained weight parameters. In this architecture, the processor and each memory interact with the processor in a novel way for data exchange.

### SUMMARY OF INVENTION

In one embodiment, a computing device for facilitating neural network operation by transforming input data through a series of layers comprises: a dynamic random access memory (DRAM) storing one or more input matrices, each containing numeric inputs; non-volatile memory device storing one or more weight matrices, each weight matrix containing weight parameters; a processor comprising a pair of static random access memories (SRAM), said processor adapted to: load the input matrix from the DRAM into a first SRAM of the pair and the weight matrix from the non-volatile memory device into a second SRAM of the pair, execute matrix operations on the loaded input matrix and the loaded weight matrix, wherein the first SRAM is connected to the DRAM via a data bus and a second SRAM is connected to the non-volatile memory device via one or more direct channels independent from the data bus, allowing a direct transfer of the weight parameters from the non-volatile memory to the second SRAM.

In another embodiment, the processor is further configured to transfer and load a corresponding output matrix produced by the matrix operations to the DRAM.

In another embodiment, the second SRAM has a size to store all partitioned weight matrix parameters allowing the processor to read and transfer the partitioned weight parameters from the non-volatile device into the second SRAM at once to complete the neural network operation for each layer.

In another embodiment, the second SRAM has a specified size to store substantial portions of partitioned said weight matrix parameters, reducing a number of weight parameter transfers from the non-volatile memory to the second SRAM to complete the neural network operation for each layer.

In another embodiment, the processor is configured to partition at least one of the input matrix and the weight matrix into partial matrices smaller than or equal to a size of a corresponding SRAM of the pair.

In another embodiment, the processor is configured to partition the weight matrix into partial weight matrices along a row direction for loading into the second SRAM through the direct channel.

In another embodiment, the processor is configured to load one or more of the partial weight matrices into the second SRAM via the direct channel when the input matrix from the DRAM is loaded into the first SRAM via the data bus.

In another embodiment, the processor is configured to perform matrix multiplication on the loaded input matrix and the loaded partitioned weight matrix and load a corresponding output matrix into the DRAM via the data bus.

In another embodiment, the non-volatile memory device comprises a plurality of non-volatile memory chips, each non-volatile memory chip storing multiple rows of the weight matrices.

In another embodiment, each non-volatile memory chip is connected to the second SRAM via the one or more direct channels in parallel.

In another embodiment, the processor is configured to partition the multiple rows of the weight matrix stored in the non-volatile memory chips along a column direction.

In another embodiment, the processor is configured to load and merge the partitioned columns of the weight matrix into the second SRAM via the one or more direct channels in parallel.

In another embodiment, the processor is configured to load a number of rows in the specified column of the weight matrix into the second SRAM simultaneously via the plurality of direct channels while loading a corresponding input matrix from the DRAM into the first SRAM via the data bus.

In another embodiment, the processor is configured to transfer and load the corresponding output produced by the matrix operations to the DRAM via the data bus.

In another embodiment, the processor is configured to: (a) partition the input matrix into groups of rows, each group having one or more rows and being fit into the first SRAM; (b) partition the weight matrix into one or more columns that fit into the second SRAM; (c) load one or more columns of the weight matrix into the second SRAM via the direct channel; (d) load the one group of the input matrix to the first SRAM via the data bus; (e) perform matrix multiplication on the one group of the input matrix and the one or more columns of the weight matrix; (f) transfer and load a corresponding output produced by the matrix multiplication to the DRAM via the data bus; (g) repeat steps (d) through (f) from a first of the groups of rows of the input matrix to a last group of the input matrix; and (h) repeat steps (c) through (f) from a first to a last group of columns of the weight matrix.

In another embodiment, the processor is configured to: (a) partition the input matrix into groups of columns, each group having one or more columns and being fit into the first SRAM; (b) partition the weight matrix into groups of rows, each group having one or more rows and being fit into the second SRAM; (c) load entire columns of the partitioned input matrix to the first SRAM via the data bus; (d) load one or more columns of a corresponding partitioned weight matrix into the second SRAM via the one or more direct channels; (e) perform matrix multiplication on the loaded entire columns of the partitioned input matrix and the loaded one or more columns of the partitioned weight matrix; (f) transfer and load corresponding output produced by the matrix multiplication to the DRAM via the data bus; (g) repeat steps (d) through (f) from a first to a last column of the partitioned weight matrix; (h) repeat steps (c) through (f) from the first to the last (662) one of the partitioned input matrices; and (i) load the output matrices stored in DRAM, resulting from the matrix multiplications of each group of the input matrix and the weight matrix, and perform an element-wise addition of the outputs of each of the partitioned input matrices and corresponding one of the partitioned weight matrices.

In another embodiment, the processor is configured to transfer the element-wise addition of the output to at least one of the second SRAM and the DRAM.

In one embodiment, a non-transitory computer-readable storage medium with instructions stored thereon, wherein the instructions are executed by a computing device to cause the computing device to: store one or more input matrices at a random access memory (DRAM), each matrix containing numeric inputs; store one or more weight metrics, each weight matrix containing weight parameters; load the input matrix from the DRAM into a first SRAM and the weight matrix from the non-volatile memory device into a second SRAM; partition at least one of the input matrix and the weight matrix into partial matrices smaller than or equal to a size of a corresponding one of the first and second SRAMs, wherein a first SRAM is connected to the DRAM via a data bus and a second SRAM is connected to the non-volatile memory device via one or more direct channels independent from the data bus, allowing a direct transfer of the weight parameters from the non-volatile memory to the second SRAM.

In another embodiment, a non-transitory computer-readable storage medium of claim 18, wherein a processor in the computing device performs to: (a) partition the input matrix into groups of rows, each said group of rows being fit into the first SRAM; (b) partition the weight matrix into one or more columns that fit into the second SRAM; (c) load one or more columns of the weight matrix into the second SRAM via the direct channel; (d) load one group of the rows of the input matrix to the first SRAM via the data bus; (e) perform matrix multiplication on the one group of rows of the input matrix and the one or more columns of the weight matrix; (f) transfer and load a corresponding output produced by the matrix multiplication to the DRAM via the data bus; (g) repeat steps (d) through (f) from a first group of rows of the input matrix to a last group of the input matrix; and (h) repeat steps (c) through (f) from a first to a last group of columns of the weight matrix.

In another embodiment, a processor in the computing device performs to: (a) partition the input matrix into groups of columns, each group of columns being fit into the first SRAM; (b) partition the weight matrix into groups of rows, each said group of rows being fit into the second SRAM; (c) load entire columns of the partitioned input matrix to the first SRAM via the data bus; (d) load one or more columns of a corresponding partitioned weight matrix into the second SRAM via the one or more direct channels; (e) perform matrix multiplication on the loaded entire columns of the partitioned input matrix and the loaded one or more columns of the partitioned weight matrix; (f) transfer and load corresponding output produced by the matrix multiplication to the DRAM via the data bus; (g) repeat steps (d) through (f) from a first to a last column of the partitioned weight matrix; (h) repeat steps (c) through (f) from a first to a last one of the partitioned input matrices; and (i) load the output matrices stored in DRAM, resulting from the matrix multiplications of each group of the input matrix and the weight matrix, and perform an element-wise addition of the outputs of each of the partitioned input matrices and corresponding one of the partitioned weight matrices.

In another embodiment, the processor transfers the element-wise addition of the output to at least one of the second SRAM and the DRAM.

### BRIEF DESCRIPTION OF THE DRAWINGS

FIG. 1 shows matrix multiplication in transformer operations.

FIG. 2 shows a processor and various memories in a conventional computing device.

FIG. 3 shows a conventional system for performing matrix multiplications in LLM computations.

FIG. 4 shows a proposed system directly utilizing weight parameters from Flash memory.

FIG. 5 is a block diagram of an example computing device with multiple memory chips according to one embodiment of the present invention.

FIGS. 6A and 6B are block diagrams of example computing devices using two examples of two different input data partitions according to some embodiments of the present invention.

FIG. 7 is a block diagram of an example computing device using an element-wise addition method of two matrices according to one embodiment of the present invention.

FIGS. 8A and 8B are simplified block diagrams of example application systems according to some embodiments of the present invention.

FIG. 9 is a simplified block diagram of a multiprocessor architecture of the proposed system according to one embodiment of the present invention.

### DETAILED DESCRIPTION OF THE INVENTION

In the following detailed description of the invention, reference is made to the accompanying drawings that form a part hereof, which is shown by way of illustration and specific embodiment. In the drawings, like numerals, features of the present invention will become apparent to those skilled in the art from the following description of the drawings. Understanding that the drawings depict only typical embodiments of the invention and are not, therefore, to be considered limiting in scope, the invention will be described with additional specificity and detail through the accompanying drawings.

Terms containing ordinal numbers, such as first, second, etc., may describe various components, but the terms do not limit the components. The above terms are used only to distinguish one component from another.

When a component is said to be “connected” or “accessed” to another component, it may be directly connected to or accessed to the other component, but it should be understood that other components may exist in between. On the other hand, when it is mentioned that a component is “directly connected” or “directly accessed” to another component, it should be understood that there are no other components in between.

Singular expressions include plural expressions unless the context clearly dictates otherwise.

In this application, it should be understood that terms such as “comprise” or “have” are meant to indicate the presence of features, numbers, steps, operations, components, parts, or combinations thereof described in the specification; however, these terms do not exclude the possibility of the additional features, numbers, steps, operations, components, parts, or combinations thereof existing or being added in advance.

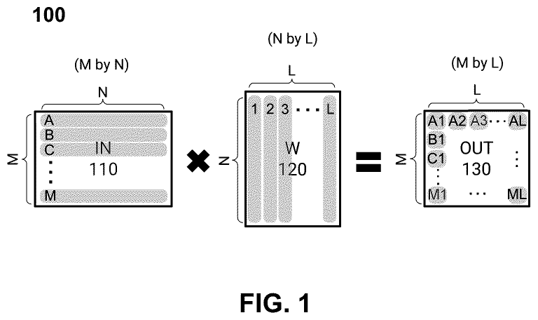

FIG. 1 shows matrix multiplication 100 in transformer operations. In FIG. 1, an OUT matrix 130 can be derived by multiplying an IN matrix 110 and a W matrix 120, referred to in neural network terminology as a “layer”.

In a neural network, a “layer as a matrix output” refers to the representation of a layer's output as a matrix. In the IN matrix 110, each row (A, B, C, . . . , M) can represent a single input data point. In W matrix W 120, each column (1, 2, 3 . . . L) can represent a single feature (or neuron). The number of columns can be equal to the number of neurons in that layer. For example, a fully connected layer with 500 neurons will have 500 columns in its output matrix. In OUT matrix 130, the value at a specific row and column represents the activation of that particular neuron for that particular data point.

An IN matrix 110, with dimensions of M by N, contains dynamic data calculated and transferred from the previous matrix multiplication in real time. In a small model, such as LLaMA[2], the IN matrix 110 size is typically tens of megabytes (MB), whereas in a large model, such as GPT-3[3], it can reach a few gigabytes (GB). A W matrix 120, with dimensions of N by L, contains weight parameters, which remain constant during inference once training is complete. Each W matrix 120 can range from tens to hundreds of MB, with the total size of W matrices in a large language model (LLM) like GPT-4 reaching up to a few terabytes (TB). An OUT matrix 130, with dimensions of M by L, which results from the matrix multiplication, then serves as the IN matrix 110 for the next matrix multiplication.

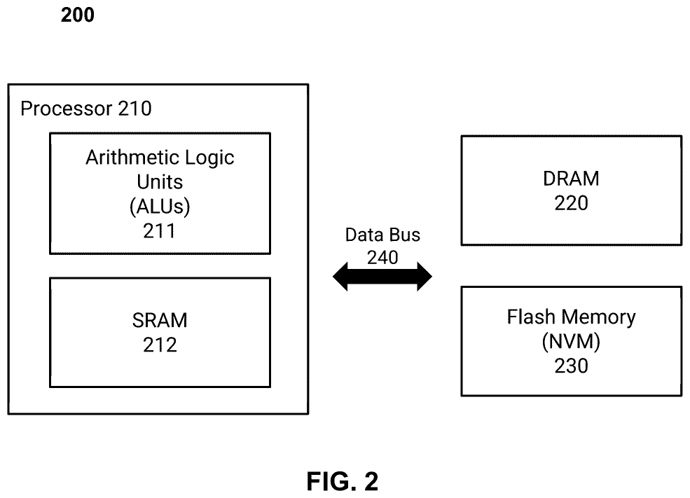

As with standard matrix multiplication, element A1 in the OUT matrix 130 is the sum of the products of each element in the first row (row A) of the IN matrix 110 with the corresponding elements in the first column (column 1) of the W matrix 120. Similarly, element A2 in the OUT matrix 130 is the sum of the products of each element in the first row (row A) of the IN matrix 110 with the elements in the second column (column 2) of the W matrix 120. Element AL is the sum of the products of each element in the first row (row A) of the IN matrix 110 with the elements in the last column (column L) of the W matrix 120. Lastly, element ML in the OUT matrix 130 is the sum of the products of each element in the last row (row M) of the IN matrix 110 with the elements in the last column (column L) of the W matrix 120. Thus, the multiplication of an IN matrix 110 with dimensions M by N and a W matrix 120 with dimensions N by L results in an OUT matrix 130 with dimensions M by L. This type of matrix multiplication is used very heavily in transformer operations. FIG. 2 shows a processor 210 and various types of memory 220, 230 in a traditional computing device 200.

A processor 210 comprises ALUs (211, Arithmetic Logic Units) for computing and SRAM 212 for storing data. SRAM 212 data can be read within a system clock period (e.g., <1 ns), though SRAM 212 capacity is usually limited to tens of megabytes (MB). Therefore, the processor 210 requires external memories to store and manage large amounts of data. DRAM 220 is a high-density volatile memory used to store several gigabytes (GB) of data and interface with processors at high speeds, such as LPDDR5 (128 GB/s), based on DRAM's high-speed read capability (˜tens of nanoseconds). On the other side, Flash Memory 230 is a non-volatile memory used to store large data, such as LLM weight parameters, up to a few terabytes (TB), although its read speed is slow (tens of microseconds).

In the traditional computing device 200, data exchange between the processor 210 and memories 220, 230 occurs through a data bus 240. Transferring the required data from the large LLM weight parameters stored in the flash memory 230 to DRAM 220 is necessary for LLM computation. At this time, the slow read speed of the flash memory 230 creates a bottleneck in the data bus, reducing the performance of the computing device 200. Thus, to handle large-scale LLM weight parameters efficiently, a new data transfer method is needed.

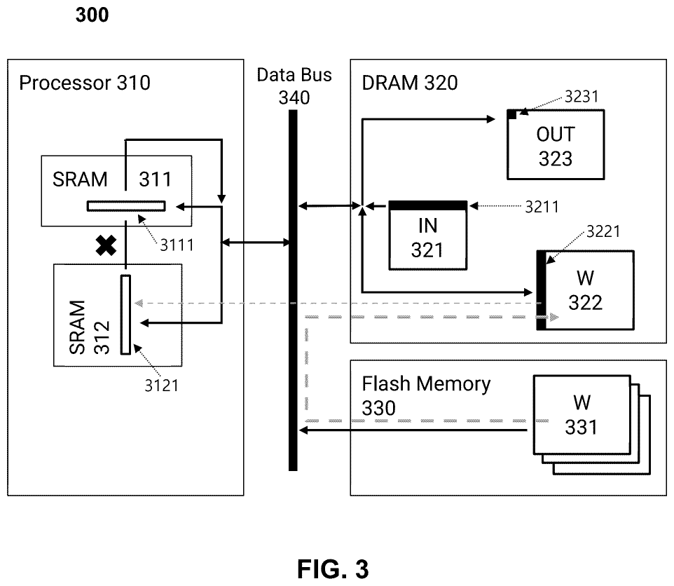

FIG. 3 shows a conventional system 300 for performing matrix multiplication for each layer of a neural network associated with LLM computations.

For example, a pair of SRAMs (Static Random Access Memories) can be used in a processor 310 for neural network operations. One SRAM 312 of the pair can be used to store the network's weights, and the other SRAM 311 can be used to store the activation values (the outputs of neurons). This allows for rapid access to both during computation. The weights could be stored in a compressed format to save space, and various data layouts (e.g., row-major, column-major) could be optimized for specific network architectures and operations.

Like FIG. 1, an IN matrix 321 is an M by N matrix, a W matrix 331 is an N by L matrix, and an OUT matrix 323 is an M by L matrix. First, the W matrix 331 is copied from Flash Memory 330 to DRAM 320 through Data Bus 340. Second, one or more rows 3211 of the IN matrix 321 and one or more columns 3221 of a copied W matrix 322 in DRAM 320 are transferred to SRAM 311 and SRAM 312, respectively, and the sum of product result 3231 is saved to the OUT matrix 323 in DRAM 320 through Data Bus 340. Note that the elements of the W matrices 331, 322 are duplicated in both Flash Memory 330 and DRAM 320, creating data traffic between the processor 310 and memories 320, 330 to copy elements from Flash Memory 330 to DRAM 320 because of a slow read speed of the flash memory 330.

Although Flash Memory 330 has a slow read speed, it has a large capacity, allowing it to store multiple W matrices 331 that contain a huge amount of weight parameters for LLM computations, as shown in FIG. 3. The W matrix 331 for the current calculation is copied to DRAM 320. Since the SRAM 311, 322 inside the processor 310 is fast but has limited capacity, a single or a few rows 3211 of the IN matrix 321 and a single or a few columns 3221 of the W matrix 322 are transferred from DRAM 320 to SRAM 311 and SRAM 312 through Data Bus 340, where the processor's ALU (not shown) performs the calculation.

The sum of the products of a single row 3111 of the IN matrix and a single column 3121 of the W matrix becomes an element 3231 of the OUT matrix 323 as a result, stored in DRAM 320. When a few rows 3111 of the IN matrix are transferred to SRAM 311 and a few columns 3121 of the W matrix are transferred to SRAM 312, the number of elements corresponding to the sum of the products in the matrix multiplication is stored as the result 3231 in the OUT matrix 323 in DRAM 320. When the sums of products of all rows of the IN matrix 321 and all columns of the W matrix 322 are calculated and stored as the elements of the OUT matrix 323 in DRAM 320, one set of computations is complete. The resulting OUT matrix 323 then becomes the IN matrix for the next set of computations. Additionally, the next W matrix 331 in Flash Memory 330 is copied to DRAM 320 for the subsequent set of computations.

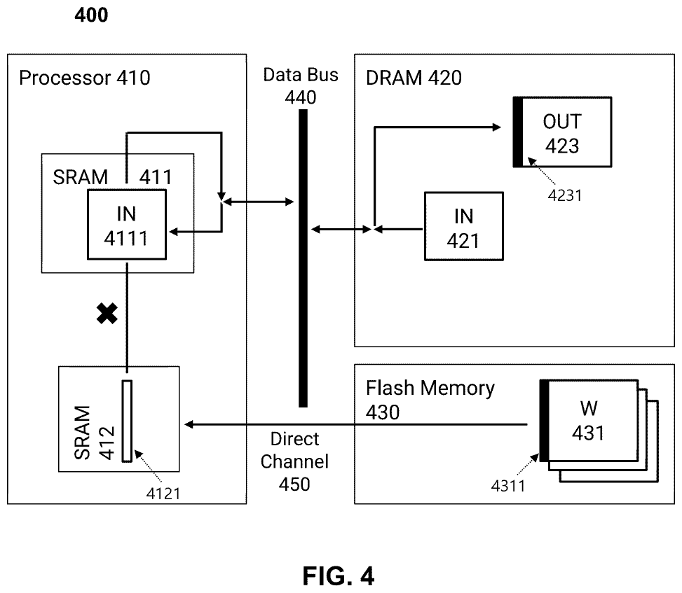

FIG. 4 shows a proposed system 400, which transfers weight parameters from Flash Memory 430 directly to the processor 410 for computation for each layer of a neural network operation.

Like the conventional system in FIG. 3, an IN matrix 421 can be an M by N matrix, a W matrix 431 can be an N by L matrix, and an OUT matrix 423 can be an M by L matrix. A direct channel 450 can be used to transfer the weight matrix 431 directly from Flash Memory 430 to SRAM 412 without sending it to DRAM 420. Considering that Flash Memory 430 read operation is significantly slower than DRAM 420, system performance can be enhanced by reducing the frequency of weight parameter transfers from Flash Memory 430.

The computation time for matrix multiplication and DRAM 420 access times for the IN 421 and OUT 423 matrices can also be hidden within the Flash Memory 430 read time. Here, weight parameters matrices 431 can be used directly from Flash Memory 430 for computation without duplication to DRAM 420. For computation, the entirety of the IN matrix 421 is first copied to SRAM 411 through Data Bus 440 to avoid redundant movement of the weight parameters matrix 431. While the IN matrix 421 is being copied to SRAM 411, one or more columns 4311 of the W matrix 431 in the Flash Memory 430 are also copied (is read and transferred) to SRAM 412 through the direct channel 450.

ALU (not shown) in the processor 410 performs matrix multiplication between the copied IN matrix 4111 and one or more than one column 4121 of the W matrix, storing the results 4231 in the OUT matrix 423 in DRAM 420 through Data Bus 440. As described in the matrix multiplication in FIG. 1, the sum of products of elements from one row of the IN matrix 4111 and one column of the W matrix 4121 forms a single element of the OUT matrix 423. As shown in FIG. 4, the IN matrix 4111 is copied to SRAM 411, and a single column 4121 of the W matrix is copied to SRAM 412 as well. When the sum of products between one column 4121 of the W matrix and all rows of the IN matrix 4111 is computed, column 4231 of the OUT matrix 423 is generated as a result and stored in DRAM 420. If multiple columns 4121 of the W matrix are copied to SRAM 412 and multiplied with the entire IN matrix 4111, then an equivalent number of columns 4231 in the OUT matrix 423 will be generated as a result and stored in DRAM 420.

As already discussed, flash memory 430 is significantly slower than DRAM 420. The proposed system is to reduce data transfer bottlenecks and maximize system performance, addressing the slow read operations and data transfer limitations of the flash memory 430.

In particular, accessing weight parameters from the flash memory 430 for each inference operation would drastically slow down the entire process. As such, the larger SRAM 412 is proposed to allow more weights to be cached, minimizing the number of slow flash memory 430 accesses. This directly impacts inference latency and throughput.

Thus, according to one embodiment of the present invention, the second SRAM 412 can have a large size to store all partitioned weight matrix parameters allowing the processor to read and transfer the partitioned weight parameters from the non-volatile device (e.g., flash memory 430) into the second SRAM 412 at once to complete the neural network operation for each layer of the neural network.

In another embodiment, the second SRAM 412 can have a specified size to store substantial portions of partitioned weight matrix parameters 4311, reducing a number of weight parameter transfers from the non-volatile memory (e.g., flash memory 430) to the second SRAM 412 to complete the neural network operation for each layer of the neural network.

In another embodiment, by having a large enough SRAM 412, the W matrix transferred from the Flash memory can be reused for the next operation, reducing the total W matrix transfer count from the Flash memory. In this way, the system performance can be enhanced by reducing the slow Flash memory access frequencies.

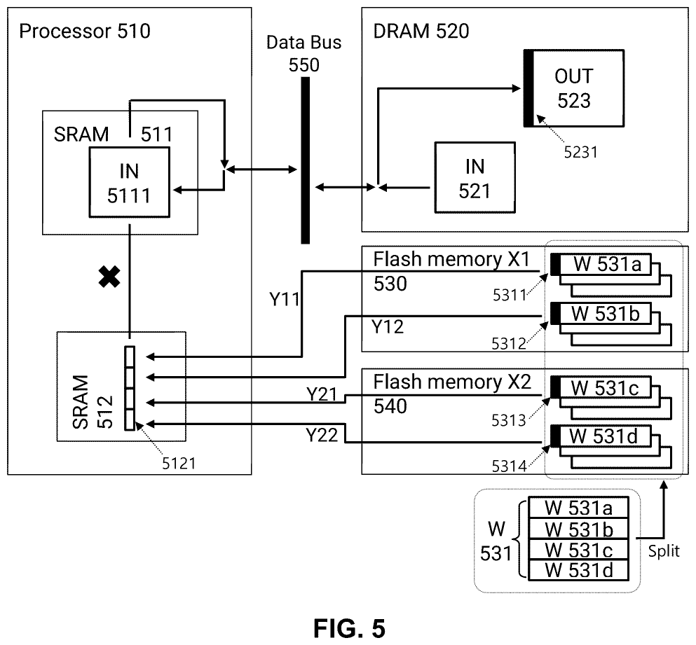

FIG. 5 is a block diagram of an example computing device with multiple memory chips according to one embodiment of the present invention. A multi-chip (X) and multi-channel (Y) data transfer method in Flash Memory is shown in FIG. 5 to improve the performance of the neural network operation for each layer of the neural network.

In FIG. 5, the part that copies the IN matrix 521 from DRAM 520 to SRAM 511 in the processor 510 through Data Bus 550 and the part that stores the computation results in the OUT matrix 523 within DRAM 520 through Data Bus 550. The IN matrix 521 is an M by N matrix, the W matrix 531 is an N by L matrix, and the OUT matrix 523 is an M by L matrix. However, the method of fetching one or more columns of the W matrix from Flash Memory differs.

The proposed system includes two Flash Memory chips, X1 530 and X2 540, with each Flash Memory containing two data transfer channels. Flash Memory X1 530 has channels Y11 and Y12, while Flash Memory X2 540 has channels Y21 and Y22. Half of the W matrix 531a and 531b are stored in X1 530, and the other half 531c and 531d are stored in X2 540.

In the example in FIG. 5, when a column of the W matrix 531 is transferred to SRAM 512 and multiplied with the IN matrix 5111 copied from DRAM 520 to compute a column 5231 of the OUT matrix 523, half of the required column of the W matrix 531 is stored in X1 530, and the other half is in X2 540. The first quarter 5311 of this column stored in X1 530 is transferred to SRAM 512 via channel Y11, and the second quarter 5312 of the column in X1 530 is transferred via channel Y12. For the portion in X2 540, the third quarter 5313 of the column is sent to SRAM 512 via Y21, and the last quarter 5314 via Y22.

Since data transfer through each channel occurs in parallel, the entire column of the W matrix 5121 can be transferred from Flash Memory 530 and 540 to SRAM 512 in the time it takes to transfer just one-fourth of the column. Thus, in the configuration shown in FIG. 5, the speed of transferring a W matrix column 5121 from Flash Memory 530 and 540 to SRAM 512 is four times faster than in FIG. 4 (X*Y=2*2=4). In general, when X represents the number of memory chips, and Y represents the number of direct channels connected to each memory chip, the factor of X*Y increases the data transfer speed between Flash Memory and SRAM (X*Y=2*2=4).

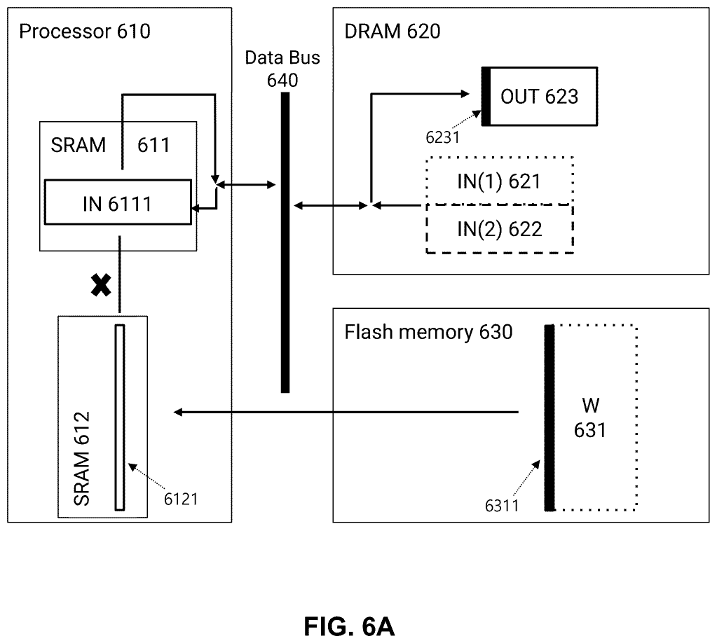

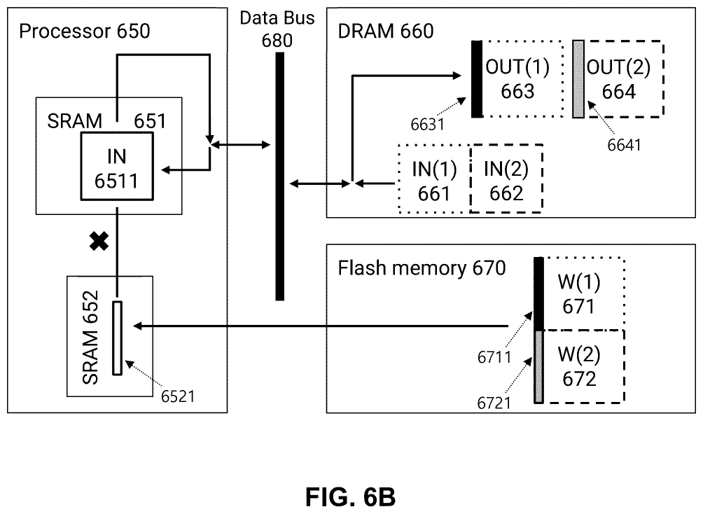

FIGS. 6A and 6B show two different matrix partitioning methods for each layer of a neural network based on the direction of the partition.

When the size of the IN matrix exceeds the capacity of SRAM, the IN matrix must be partitioned, and the matrix multiplication is processed over multiple cycles. In FIGS. 6A and 6B, like FIGS. 3, 4, and 5, the IN matrix is an M by N matrix, the W matrix is an N by L matrix, and the OUT matrix is an M by L matrix.

In FIG. 6A, the IN matrix is partitioned into IN(1) 621 and IN(2) 622 along the column direction. For each IN(1) 621 and IN(2) 622 matrix, the W matrix 631 is repeatedly read and transferred, resulting in duplicated data transfers from Flash Memory 630. As mentioned in FIG. 4 and FIG. 5, one or more columns 6311 of the W matrix 631 stored in Flash Memory 630 can be transferred directly to SRAM 612. FIG. 6A illustrates an example where columns 6311 of the W matrix 631 are sequentially transferred to SRAM 612 for matrix multiplication.

First, the IN(1) matrix 621, part of the IN matrix stored in DRAM 620, is transferred to SRAM 611 inside the processor 610 through Data Bus 640. While the IN(1) matrix 621 is being copied to SRAM 611, one or more than one column 6311 of the W matrix 631, stored in Flash Memory 630, are also directly transferred to SRAM 612, and the matrix multiplication of transferred data 6111 and 6121 is performed, with the result 6231 saved in the OUT matrix 623 in DRAM 620. Since the transferred IN(1) matrix 6111 represents half of the IN matrix in the column direction, only half of the first column of the entire OUT matrix 623 is calculated and stored. Next one or more than one column of the W matrix 631 is transferred from Flash Memory 630 to SRAM 612 to perform multiplication with the IN(1) matrix 6111, and the result is stored in the next columns' first half of the OUT matrix 623 in DRAM 620. This process continues sequentially for each subsequent column of the W matrix 631 until the final column is transferred to SRAM 612, multiplied by the IN(1) matrix 6111, and the result is saved in the OUT matrix 623 in DRAM 620. This process yields a partial calculation result in the column direction of the entire OUT matrix 623, corresponding to the partition of the IN matrix into IN(1) 621 and IN(2) 622 in the column direction.

Second, the IN(2) matrix 622, part of the IN matrix stored in DRAM 620, is transferred to SRAM 611. In the same manner as with the multiplication performed with the IN(1) matrix 621, each column of the W matrix 631, from the first to the last, is sequentially transferred to SRAM 612 to perform multiplication with the IN(2) matrix 6111, which has been copied from DRAM 620 to SRAM 611. The remaining half of the OUT matrix 623 in DRAM 620 is then calculated and stored. In conclusion, in the case of FIG. 6A, the process of sequentially transferring each column of the W matrix 631 stored in Flash Memory 630 to SRAM 612, from the first to the last column, was performed twice in total: once for the multiplication with the IN(1) matrix 621 and once again for the multiplication with the IN(2) matrix 622, requiring repeated read and transfer operations. The need to repeatedly transfer columns 6311 of the W matrix 631 stored in Flash Memory 630 to SRAM 612 can be considered a drawback of the method of partitioning the IN matrix in the column direction, as presented in FIG. 6A.

In FIG. 6B, the IN matrix is partitioned into IN(1) 661 and IN(2) 662 in the row direction. For the IN(1) 661 and IN(2) 662 matrices, the W(1) 671 and W(2) 672 matrices are read and transferred, respectively, which avoids duplicated data transfer from Flash Memory 670, though it requires an element-wise addition of the OUT(1) 663 and OUT(2) 664 matrices to obtain the final OUT matrix. First, the IN(1) matrix 661, which is partitioned in the row direction from the IN matrix, is transferred from DRAM 660 to SRAM 651 inside the processor 650 through Data Bus 680. Since the multiplication of the IN matrix and W matrix is calculated by the sum of the products of elements from the rows of the IN matrix and the columns of the W matrix, the W matrix should also be divided in the column direction into W(1) 671 and W(2) 672 matrices accordingly. While the IN(1) matrix 661 is being copied to SRAM 651, one or more than one column 6711 of the W(1) matrix 671 in Flash Memory 670 is directly transferred to SRAM 652. The multiplication result of the IN(1) matrix 6511 and one or more than one column 6521 of the W(1) matrix 671 is stored as the corresponding number of columns 6631 of the OUT(1) matrix 663 in DRAM 660 through Data Bus 680.

For the next computation, the next one or more than one column of the W(1) matrix 671 is transferred to SRAM 652, and the result of the multiplication with the IN(1) matrix 6511 is stored as the next columns of the OUT(1) matrix 663. Sequentially, each column of the W(1) matrix 671 is transferred to SRAM 652 and computed, with the results stored in the OUT(1) matrix 663.

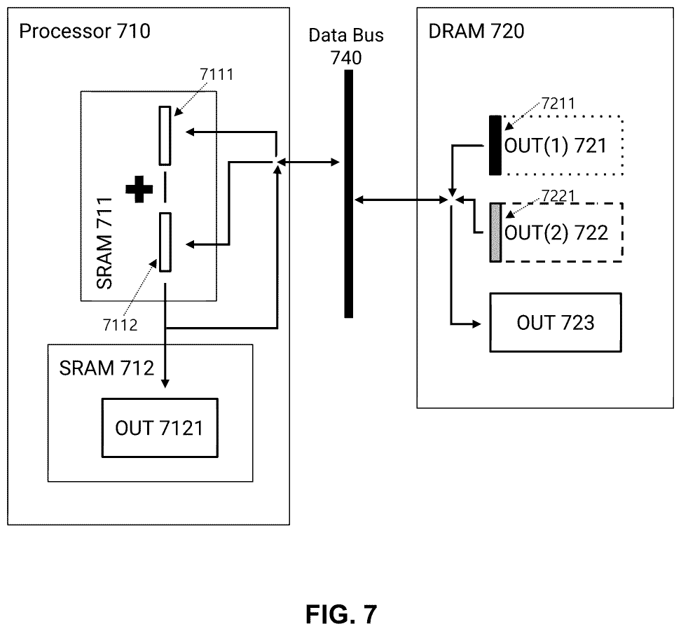

Second, the IN(2) matrix 662, which is partitioned in the row direction from the IN matrix, is transferred from DRAM 660 to SRAM 651 through Data Bus 680. Similarly to the computation with the IN(1) matrix 661, for the computation with the IN(2) matrix 662, each column of the W(2) matrix 6721 from the first to the last is directly transferred from Flash Memory 670 to SRAM 652, where it is multiplied with the IN(2) matrix 6511. The resulting output is stored as column 6641 of the OUT(2) matrix 664 in DRAM 660. Finally, an element-wise addition of the OUT(1) 663 and OUT(2) 664 matrices is performed to produce the entire OUT matrix, which will be stored in DRAM 660 as the final result. The element-wise addition of the two matrices will be explained in detail in FIG. 7.

In the case of FIG. 6A, there is an advantage in that the element-wise addition process for the OUT matrices is not required. However, it has the drawback of repeatedly transferring the W matrix from Flash Memory to SRAM. Unlike the case in FIG. 6A, the example in FIG. 6B does not involve duplicated reads and transfers of the W matrix from Flash Memory 670 to SRAM 652. In the proposed system, which focuses on reducing the number of read and transfer operations from Flash Memory to SRAM, the row-direction matrix partition in FIG. 6B is more appropriate.

FIG. 7 shows an element-wise addition method of two matrices. One or more columns or partial matrices 7211, 7221 of OUT(1) 721 and OUT(2) 722 are copied from DRAM 720 to SRAM 711 within the processor 710 through Data Bus 740. An element-wise addition is performed for corresponding elements 7111, 7112 of OUT(1) 721 and OUT(2) 722 matrices. For example, the (1,1) element of OUT(1) 721 matrix is added to the (1,1) element of OUT(2) 722 matrix, resulting in the (1,1) element of the final OUT matrix. Similarly, the (2,4) element of OUT(1) 721 matrix is added to the (2,4) element of OUT(2) 722 matrix, yielding the (2,4) element of the final OUT matrix. In general, the (m,n) element of OUT(1) 721 matrix is added to the (m,n) element of OUT(2) 722 matrix to form the (m,n) element of the final OUT matrix. Once the element-wise addition is completed for one or more columns or partial matrices of OUT(1) 721 and OUT(2) 722 copied to SRAM, the remaining columns or partial matrices of OUT(1) 721 and OUT(2) 722 stored in DRAM 720 are sequentially copied to SRAM 711 through Data Bus 740 to perform element-wise addition. Upon completion of addition for all elements, the final OUT matrix is complete. After the element-wise addition operation is conducted in the processor 710, the final OUT matrix 723 is stored in DRAM 720 through Data Bus 740, or alternatively, the final OUT matrix 7121 can be stored in another SRAM 712 for the next layer's matrix multiplication without being transferred to DRAM 720.

The additional explanation regarding the matrix partition method in FIG. 6B and the matrix element-wise addition in FIG. 7 is as follows. As mentioned in FIG. 1, the IN matrix is an M by N matrix, the W matrix is an N by L matrix, and the OUT matrix is an M by L matrix.

When the IN matrix is divided into two matrices along the row direction, the IN(1) 661 and IN(2) 662 matrices become M by N/2 matrices. Accordingly, the W matrix is divided into two matrices along the column direction, resulting in W(1) 671 and W(2) 672 matrices, which are N/2 by L matrices.

The matrix multiplication of IN(1) 661 and W(1) 671, as well as IN(2) 662 and W(2) 672, involves the multiplication of an M by N/2 matrix with an N/2 by L matrix, yielding M by L matrices as a result. Thus, both OUT(1) 663 and OUT(2) 664 matrices are M by L matrices.

The element-wise matrix addition in FIG. 7 involves adding the corresponding elements of the two matrices 721 and 722, which does not change the dimensions of the matrices. Consequently, the final OUT matrix 723 also remains an M by L matrix.

In conclusion, the dimensions (M by L) of the OUT matrix 130 resulting from the multiplication of the IN matrix 110 (M by N) and the W matrix 120 (N by L) described in FIG. 1 are identical to the dimensions (M by L) of the OUT matrix 723 obtained through the matrix partition method in FIG. 6B and the subsequent element-wise matrix addition in FIG. 7.

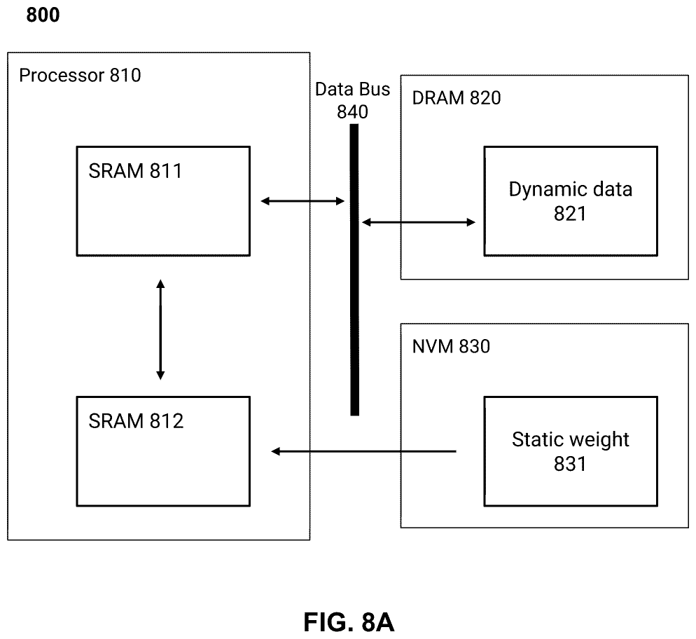

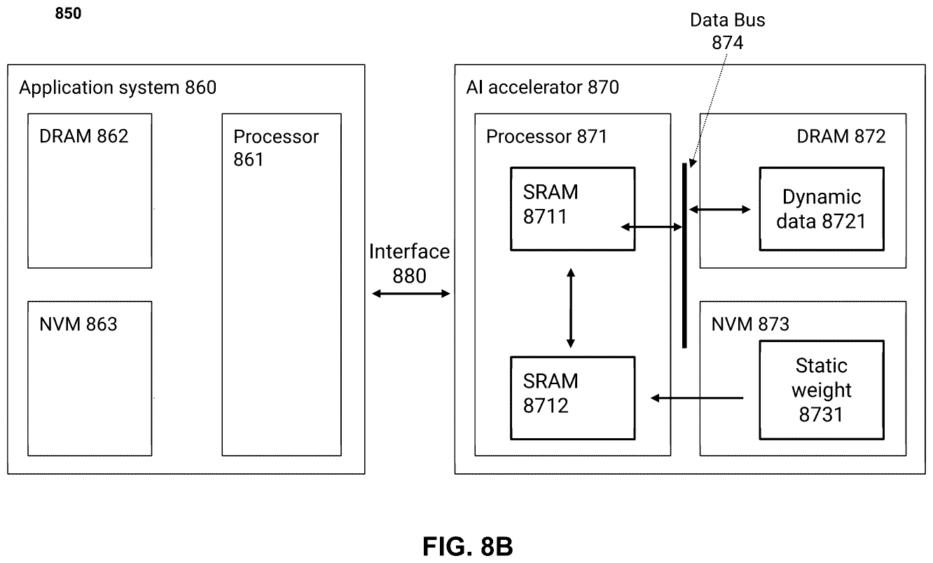

FIGS. 8A and 8B show example applications according to embodiments of the present invention. As shown in FIG. 8A, the processor 810 can be an application processor (AP), a microcontroller unit (MCU), CPU, GPU, or similar, integrated with NVM 830 and DRAM 820 and having an optimized data flow for NVM 830. The integrated system 800 in FIG. 8A illustrates the data flow of static weight parameter 831 in the present invention, as shown from FIG. 4 to FIG. 6. In the non-volatile memory (NVM) 830, the static weight parameters 831, which are huge-capacity static pre-trained data, are stored. Dynamic data 821 that changes during the LLM computation process is stored in DRAM 820, corresponding to the IN and OUT matrices in FIG. 4 through FIG. 6. For each computation, part of the weight parameter 831 data from the NVM 830 is directly transferred to SRAM 812 within the processor 810. Dynamic data 821, such as the IN matrix stored in DRAM 820, is transferred to another SRAM 811 in the processor 810 via Data Bus 840, where the matrix computation is performed by the processor's ALU (not shown), and the result is saved as the OUT matrix in DRAM 820 through Data Bus 840.

FIG. 8B shows another example of a system 850 interfacing with the application system 860 as an independent AI accelerator 870. The application system 860 can include various examples, such as mobile devices, personal computers, or automobiles. Consequently, the processor 861 of the application system 860 could be a general-purpose CPU, AP, MCU, GPU, etc. Like other systems, the application system 860 also contains DRAM 862 and NVM 863 to carry out the necessary applications. The AI accelerator 870, similar to the system in FIG. 8A, comprises SRAM 8711, 8712 within its processor 871, DRAM 872 and NVM 873. Like FIG. 8A, the Dynamic Data 8721 in DRAM 872 is transferred to SRAM 8711 via the Data Bus 874, and the Static Weight data 8731 in NVM 873 is directly transferred to SRAM 8712. The results calculated in the processor 871 are stored in DRAM 872 via the Data Bus 874. However, in the case of FIG. 8B, the AI accelerator 870 is primarily responsible for performing LLM computations, thus reducing the load on the application system 860 and only delivering the computation results via the interface 880. This design enhances the efficiency of the overall system. In this case, the interface 880 between the application system 860 and AI accelerator 870 could be USB, Bluetooth, Wi-Fi, etc.

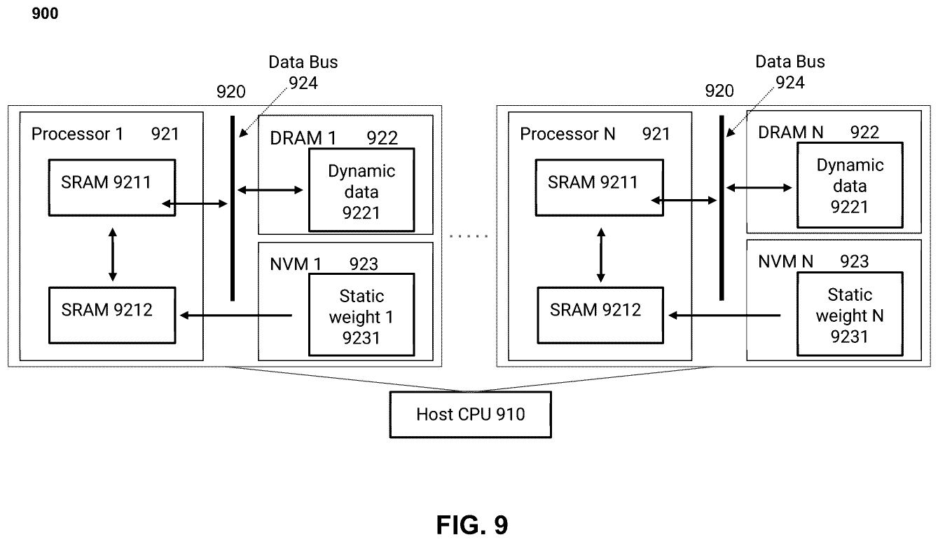

FIG. 9 shows a multiprocessor architecture 900 for large-scale acceleration that leverages the parallelism of multiple computing devices. Assuming the proposed system shown in FIG. 4 as a single computing device, the entire architecture 900 comprises a host CPU 910 and N computing devices 920. Each of the N processors, from processor 1 to processor N, controls its corresponding computing device 920 and performs the assigned LLM computations. Each computing device 920 comprises DRAM 922, non-volatile memory (NVM) 923 and Data Bus 924, and, as described in FIG. 4, the static data 9231, weight parameters, stored in each NVM 923 are directly transferred to the SRAM 9212 within the corresponding computing device's processor 921. In each computing device's DRAM 922, dynamic data 9221 such as the IN matrix and OUT matrix are stored. The IN matrix is transferred to another SRAM 9211 within each processor 921 via Data Bus 924, where matrix multiplication with the weight parameters is performed by the processor's ALU (not shown). The computation result is stored as the OUT matrix in DRAM 922 through Data Bus 924, which is used as the IN matrix for the subsequent computation. The host CPU 910 optimally distributes the overall LLM computations across the processors 921 in the N computing devices 920 to maximize the efficiency of the parallel system. Pre-trained static weight parameter data 9231 is carefully stored across the N NVMs 923 to be appropriately distributed for each computing device's LLM computation, thereby minimizing data movement between computing devices 920.

What is claimed is:

1. A computing device for facilitating neural network operation by transforming input data through a series of layers, said computing device comprising:
a dynamic random access memory (DRAM) storing one or more input matrices, each containing numeric inputs;
non-volatile memory device storing one or more weight matrices, each weight matrix containing weight parameters;
a processor comprising a pair of static random access memories (SRAM), said processor adapted to:
load the input matrix from the DRAM into a first SRAM of the pair and the weight matrix from the non-volatile memory device into a second SRAM of the pair,
execute matrix operations on the loaded input matrix and the loaded weight matrix, wherein the first SRAM is connected to the DRAM via a data bus and a second SRAM is connected to the non-volatile memory device via one or more direct channels independent from the data bus, allowing a direct transfer of the weight parameters from the non-volatile memory to the second SRAM.

2. The computing device of claim 1, wherein the processor is further configured to transfer and load a corresponding output matrix produced by the matrix operations to the DRAM.

3. The computing device of claim 1, wherein the second SRAM has a size to store all partitioned weight matrix parameters allowing the processor to read and transfer the partitioned weight parameters from the non-volatile device into the second SRAM at once to complete the neural network operation for each layer.

4. The computing device of claim 1, wherein the second SRAM has a specified size to store substantial portions of partitioned said weight matrix parameters, reducing a number of weight parameter transfers from the non-volatile memory to the second SRAM to complete the neural network operation for each layer.

5. The computing device of claim 1, wherein the processor is configured to partition at least one of the input matrix and the weight matrix into partial matrices smaller than or equal to a size of a corresponding SRAM of the pair.

6. The computing device of claim 5, wherein the processor is configured to partition the weight matrix into partial weight matrices along a row direction for loading into the second SRAM through the direct channel.

7. The computing device of claim 6, wherein the processor is configured to load one or more of the partial weight matrices into the second SRAM via the direct channel when the input matrix from the DRAM is loaded into the first SRAM via the data bus.

8. The computing device of claim 7, wherein the processor is configured to perform matrix multiplication on the loaded input matrix and the loaded partitioned weight matrix and load a corresponding output matrix into the DRAM via the data bus.

9. The computing device of claim 5, wherein the non-volatile memory device comprises a plurality of non-volatile memory chips, each non-volatile memory chip storing multiple rows of the weight matrices.

10. The computing device of claim 9, wherein each non-volatile memory chip is connected to the second SRAM via the one or more direct channels in parallel.

11. The computing device of claim 10, wherein the processor is configured to partition the multiple rows of the weight matrix stored in the non-volatile memory chips along a column direction.

12. The computing device of claim 11, wherein the processor is configured to load and merge the partitioned columns of the weight matrix into the second SRAM via the one or more direct channels in parallel.

13. The computing device of claim 12, wherein the processor is configured to load a number of rows in the specified column of the weight matrix into the second SRAM simultaneously via the plurality of direct channels while loading a corresponding input matrix from the DRAM into the first SRAM via the data bus.

14. The computing device of claim 13, wherein the processor is configured to transfer and load corresponding output produced by the matrix operations to the DRAM via the data bus.

15. The computing device of claim 5, wherein the processor is configured to:
(a) partition the input matrix into multiple row groups, each group having one or more rows and being fit into the first SRAM;
(b) partition the weight matrix into one or more columns that fit into the second SRAM;
(c) load one or more columns of the weight matrix into the second SRAM via the direct channel;
(d) load the one group of the input matrix to the first SRAM via the data bus;
(e) perform matrix multiplication on the one group of the input matrix and the one or more columns of the weight matrix;
(f) transfer and load a corresponding output produced by the matrix multiplication to the DRAM via the data bus;
(g) repeat steps (d) through (f) from a first of the row groups of the input matrix to a last group of the input matrix; and
(h) repeat steps (c) through (f) from a first to a last group of columns of the weight matrix.

16. The computing device of claim 5, wherein the processor is configured to:
(a) partition the input matrix into multiple column groups, each column group having one or more columns and being fit into the first SRAM;
(b) partition the weight matrix into multiple row groups, each row group having one or more rows and being fit into the second SRAM;
(c) load entire columns of the partitioned input matrix to the first SRAM via the data bus;
(d) load one or more columns of a corresponding partitioned weight matrix into the second SRAM via the one or more direct channels;
(e) perform matrix multiplication on the loaded entire columns of the partitioned input matrix and the loaded one or more columns of the partitioned weight matrix;
(f) transfer and load corresponding output produced by the matrix multiplication to the DRAM via the data bus;
(g) repeat steps (d) through (f) from a first to a last column of the partitioned weight matrix;
(h) repeat steps (c) through (f) from a first to a last one of the partitioned input matrices; and
(i) load the output matrices stored in DRAM, resulting from the matrix multiplications of each group of the input matrix and the weight matrix, and perform an element-wise addition of the outputs of each of the partitioned input matrices and corresponding one of the partitioned weight matrices.

17. The computing device of claim 16, wherein the processor is configured to transfer the element-wise addition of the output to at least one of the second SRAM and the DRAM.

18. A non-transitory computer-readable storage medium with instructions stored thereon, wherein the instructions are executed by a computing device to cause the computing device to:
store one or more input matrices at a random access memory (DRAM), each matrix containing numeric inputs;
store one or more weight metrics, each weight matrix containing weight parameters;
load the input matrix from the DRAM into a first SRAM and the weight matrix from the non-volatile memory device into a second SRAM;
partition at least one of the input matrix and the weight matrix into partial matrices smaller than or equal to a size of a corresponding one of the first and second SRAMs,
wherein a first SRAM is connected to the DRAM via a data bus and a second SRAM is connected to the non-volatile memory device via one or more direct channels independent from the data bus, allowing a direct transfer of the weight parameters from the non-volatile memory to the second SRAM.

19. A non-transitory computer-readable storage medium of claim 18, wherein a processor in the computing device performs to:
(a) partition the input matrix into multiple row groups, each row group being fit into the first SRAM;
(b) partition the weight matrix into one or more columns that fit into the second SRAM;
(c) load one or more columns of the weight matrix into the second SRAM via the direct channel;
(d) load one group of the rows of the input matrix to the first SRAM via the data bus;
(e) perform matrix multiplication on the one group of rows of the input matrix and the one or more columns of the weight matrix;
(f) transfer and load a corresponding output produced by the matrix multiplication to the DRAM via the data bus;
(g) repeat steps (d) through (f) from a first group of rows of the input matrix to a last group of the input matrix; and
(h) repeat steps (c) through (f) from a first to a last group of columns of the weight matrix.

20. A non-transitory computer-readable storage medium of claim 18, wherein a processor in the computing device performs to:
(a) partition the input matrix into multiple column groups, each column group being fit into the first SRAM;
(b) partition the weight matrix into multiple row groups, each row group being fit into the second SRAM;
(c) load entire columns of the partitioned input matrix to the first SRAM via the data bus;
(d) load one or more columns of a corresponding partitioned weight matrix into the second SRAM via the one or more direct channels;
(e) perform matrix multiplication on the loaded entire columns of the partitioned input matrix and the loaded one or more columns of the partitioned weight matrix;
(f) transfer and load corresponding output produced by the matrix multiplication to the DRAM via the data bus;
(g) repeat steps (d) through (f) from a first to a last column of the partitioned weight matrix;
(h) repeat steps (c) through (f) from a first to a last one of the partitioned input matrices; and
(i) load the output matrices stored in DRAM, resulting from the matrix multiplications of each group of the input matrix and the weight matrix, and perform an element-wise addition of the outputs of each of the partitioned input matrices and corresponding one of the partitioned weight matrices.

21. A non-transitory computer-readable storage medium of claim 20, wherein the processor transfers the element-wise addition of the output to at least one of the second SRAM and the DRAM.
